(19) United States
(12) Patent Application Publication
(10) Pub. No.: US 2011/0153883 A1
(43) Pub. Date: Jun. 23, 2011

(54) DUAL FIELD INSTRUMENT

(75) Inventor: Dai KATO, Musashino-shi (JP)

(73) Assignee: YOKOGAWA ELECTRIC CORPORATION, Tokyo (JP)

(21) Appl. No.: 12/969,144

(22) Filed: Dec. 15, 2010

(30) Foreign Application Priority Data
Dec. 17, 2009 (JP) P2009-285836

(51) Int. Cl. G06F 13/36

(52) U.S. Cl. 710/100

(57) ABSTRACT

A dual field instrument may include a first microprocessor that includes a first address bus and a first data bus and performs a first operation process, a second microprocessor that includes a second address bus and a second data bus performs a second operation process that is the same with the first operation process, a first code analysis unit that compresses and encodes histories of data on at least one of the first address bus and the first data bus to generate a first code, a second code analysis unit that compresses and encodes histories of data on at least one of the second address bus and the second data bus to generate a second code, and a first collating unit that collates the first code with the second code so as to determine whether or not the first code corresponds with the second code.

### BACKGROUND OF THE INVENTION

1. Field of the Invention

The present invention relates to a dual field instrument that includes a first microprocessor and a second microprocessor performing the same operation process and detects abnormality by collating the operation of the first microprocessor with the operation of the second microprocessor.

Priority is claimed on Japanese Patent Application No. 2009-285836, filed Dec. 17, 2009, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

Japanese Unexamined Patent Application, First Publication No. 2005-309913 discloses a transmitter that includes an operation system of performing an operation based on a sensor measurement value. The transmitter performs an inverse-operation on the result of the operation system to regenerate the sensor measurement value. The transmitter collates the sensor measurement value regenerated by the inverse-operation system with the original sensor measurement value to detect abnormalities. If both of the sensor measurement values do not coincide, then the transmitter can detect an abnormal state.

In some cases, the inverse-operation system cannot regenerate the sensor measurement value. For example, if one operation result is operated based on a plurality of sensor measurement values in the operation system, then the inverse-operation system cannot be configured.

Japanese Unexamined Patent Application, First Publication No. 2006-209523 discloses an information processor that doubly performs the same operation and outputs one operation result to the outside. In the information processor, two microprocessors perform the same operation process. The operation results at an arbitrary step or the attached information of the operation are exchanged between the two microprocessors to be collated. If they do not coincide, the information processor determines an abnormal state and outputs an abnormality annunciation signal to the outside.

To detect various abnormalities and to detect them quickly, the frequency of collating the information exchanged between the two microprocessors needs to be increased. Then, the burden on the microprocessors is increased.

### SUMMARY

A dual field instrument may include a first microprocessor that includes a first address bus and a first data bus, the first microprocessor performing a first operation process, a second microprocessor that includes a second address bus and a second data bus, the second microprocessor performing a second operation process, the second operation process being the same with the first operation process, a first code analysis unit that compresses and encodes histories of data on at least one of the first address bus and the first data bus to generate a first code by a first process, a second code analysis unit that compresses and encodes histories of data on at least one of the second address bus and the second data bus to generate a second code by a second process, and a first collating unit that collates the first code with the second code so as to determine whether or not the first code corresponds with the second code.

The first process may be the same with the second process.

The first process may be performed when data on the first address bus is within a specified address area. The second process may be performed when data on the second address bus is within the specified address area.

The specified address area may be an address area of a memory that stores a program defining at least one of the first operation process and the second operation process.

Each of the first code analysis unit and the second code analysis unit may include a linear feedback shift register.

The dual field instrument may further include a signal output unit. If the first collating unit determines that the first code corresponds with the second code, then the signal output unit may output one of a first operation result of the first operation process and a second operation result of the second operation process. If the first collating unit determines that the first code does not corresponds with the second code, then the signal output unit may output an abnormality annunciation signal.

The dual field instrument may further include a first information exchange unit that receives the first code from the first code analysis unit, the first information exchange unit receiving the second code from a second information exchange unit, the first information exchange unit outputting the first code and the second code to the first collating unit, the second information exchange unit that receives the second code from the second code analysis unit, the second information exchange unit receiving the first code from the first information exchange unit, the first information exchange unit outputting the first code and the second code to a second collating unit, and the second collating unit that receives the first code and the second code from the second information exchange unit, the second collating unit collating the first code with the second code so as to determine whether or not the first code corresponds with the second code. The first collating unit may receive the first code and the second code from the first information exchange unit.

A dual field instrument may include a first microprocessor that receives a sensor measurement value, the first microprocessor performing a first operation process to generate a first output value, the first microprocessor outputting a first code, a second microprocessor that receives the sensor measurement value, the second microprocessor performing a second operation process to generate a second output value, the second microprocessor outputting a second code, the second operation process being the same with the first operation process, a first information exchange unit that receives the first code from the first microprocessor, the first information exchange unit receiving the second code from a second information exchange unit, the first information exchange unit outputting the first code and the second code to a first collating unit, the second information exchange unit that receives the second code from the second microprocessor, the second information exchange unit receiving the first code from the first information exchange unit, the second information exchange unit outputting the first code and the second code to a second collating unit, the first collating unit that receives the first code and the second code from the first information exchange unit, the first collating unit collating the first code with the second code so as to determine whether or not the first code corresponds with the second code, and the second collating unit that receives the first code and the second code from the second information exchange unit, the second collating unit collating the first code with the second code so as to determine whether or not the first code corresponds with the second code.

If the first collating unit determines that the first code does not correspond with the second code, then the signal output unit may output a first discrepancy detection signal. If the second collating unit determines that the first code does not correspond with the second code, then the signal output unit may output a second discrepancy detection signal.

The dual field instrument may further include a standardized signal output unit that receives the first output value from the first microprocessor, the standardized signal output unit receiving the second output value from the second microprocessor, the standardized signal output unit receiving the first discrepancy detection signal from the first collating unit, the standardized signal output unit receiving the second discrepancy detection signal from the second collating unit, the standardized signal output unit outputting a standardized signal current.

If neither the first discrepancy detection signal nor the second discrepancy detection signal is input to the standardized signal output unit, then the standardized signal output unit may output 4-20 mA current as the standardized signal current, based on at least one of the first output value of the first microprocessor and the second output value from the second microprocessor.

If at least one of the first discrepancy detection signal and the second discrepancy detection signal is input to the standardized signal output unit, then the standardized signal output unit may output an predetermined abnormality annunciation current as the standardized signal current.

If the first output value from the first microprocessor is different from the second output value from the second microprocessor, then the standardized signal output unit may output an predetermined abnormality annunciation current as the standardized signal current.

The first microprocessor may include a first CPU that performs the first operation process, a first input-output unit that receives the sensor measurement value, the first input-output unit outputting the first output value, a first memory that stores a first program performing the first operation process, a first code analysis unit that outputs the first bus observation code, a first address bus that connects between the first CPU, the first input-output unit, the first memory and the first code analysis unit, and a first data bus that connects between the first CPU, the first input-output unit, the first memory and the first code analysis unit. The second microprocessor may include a second CPU that performs the second operation process, a second input-output unit that receives the sensor measurement value, the second input-output unit outputting the second output value, a second memory that stores a second program performing the second operation process, a second code analysis unit that outputs the second bus observation code, a second address bus that connects between the second CPU, the second input-output unit, the second memory and the second code analysis unit, and a second data bus that connects between the second CPU, the second input-output unit, the second memory and the second code analysis unit.

The first CPU may output a first bus clock. The first code analysis unit may receive the first bus clock. The second CPU may output a second bus clock. The second code analysis unit may receive the second bus clock.

The first code analysis unit may read first data on the first address bus and the first data bus. The first code analysis unit may encode and compress the first data based on the first bus clock to generate the first bus observation code. The second code analysis unit may read second data on the second address bus and the second data bus. The second code analysis unit may encode and compress the second data based on the second bus clock to generate the second bus observation code.

The first code analysis unit may output a change history of a data pattern in each of the first address bus and the data address bus as the first bus observation code. The second code analysis unit may output a change history of a data pattern in each of the second address bus and the second data bus as the second bus observation code. The first bus observation code and the second bus observation code may be codes of serial bit stream.

If data on the first address bus is within a first specified address area, then the first code analysis unit may encode and compress the first data. If data on the second address bus is within a second specified address area, then the second code analysis unit may encode and compress the second data.

Each of the first code analysis unit and the second code analysis unit may include a linear feedback shift register.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of a dual field instrument in accordance with a first preferred embodiment of the present invention;

FIG. 2 is a block diagram illustrating a configuration of the first microprocessor and the second microprocessor of FIG. 1; and

FIG. 3 is a flowchart illustrating an operation of the first code analysis unit and the second code analysis unit of FIG. 1 when only data in a specified address area is encoded.

### DETAILED DESCRIPTION OF THE PREFERRED EMBODIMENTS

The dual field instrument of the present invention can detect abnormalities with high precision and high speed while the burden of the microprocessor is suppressed.

In the dual field instrument of the present invention, each history of multiple-bit data on the address bus or the data bus in the two microprocessors is compressed and encoded to generate codes. Then the generated codes are collated. The burden on the microprocessor is suppressed. An abnormality can be detected with high precision and high speed.

The present invention will be now described herein with reference to illustrative embodiments. Those skilled in the art will recognize that many alternative embodiments can be accomplished using the teaching of the present invention and that the present invention is not limited to the embodiments illustrated herein for explanatory purposes.

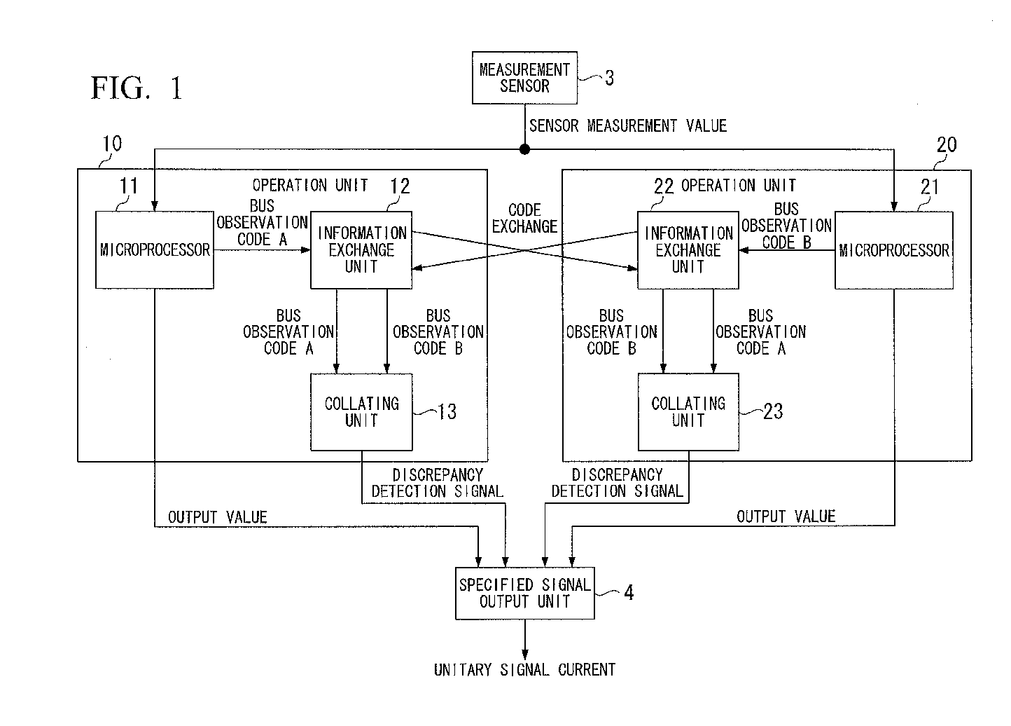

A first preferred embodiment of the present invention will be described. FIG. 1 is a block diagram illustrating a configuration of a dual field instrument in accordance with the first preferred embodiment of the present invention.

The dual field instrument includes a measurement sensor 3, a first operation unit 10, a second operation unit 20, and a standardized signal output unit 4. The measurement sensor 3 outputs a sensor measurement value. The first operation unit 10 and the second operation unit 20 perform the same operation based on the sensor measurement value output from the measurement sensor 3. The standardized signal output unit 4 outputs a single signal as a standardized signal current based on signals and output values that are output from the first operation unit 10 and the second operation unit 20.

The measurement sensor 3 includes a sensor unit and a measurement circuit. The sensor unit measures physical quantities such as a temperature and a pressure. The measurement circuit converts an output signal of the sensor unit to a digital value, and outputs it as the sensor measurement value.

The first operation unit 10 and the second operation unit 20 have the same configuration.

The first operation unit 10 includes a first microprocessor 11, a first information exchange unit 12, and a first collating unit 13. The first microprocessor 11 receives the sensor measurement value from the measurement sensor 3 and performs the above-mentioned operation to output a bus observation code A to the first information exchange unit 12 and output a first output value to the standardized signal output unit 4. The first information exchange unit 12 receives the bus observation code A from the first microprocessor 11 and outputs the bus observation code A to the first collating unit 13 and a second information exchange unit 22 in the second operation unit 20. Also, the first information exchange unit 12 receives a bus observation code B from the second information exchange unit 22 and outputs the bus observation code B to the first collating unit 13. That is, the first information exchange unit 12 performs a code exchange. The first collating unit 13 receives the bus observation code A and the bus observation code B from the first information exchange unit 12 and collates the bus observation code A with the bus observation code B. If the bus observation code A does not correspond to the bus observation code B, then the first collating unit 13 outputs a first discrepancy detection signal to the standardized signal output unit 4.

In the same way, the second operation unit 20 includes a second microprocessor 21, a second information exchange unit 22, and a second collating unit 23. The second microprocessor 21 receives the sensor measurement value from the measurement sensor 3 and performs the above-mentioned operation to output a bus observation code B to the second information exchange unit 22 and to output a second output value to the standardized signal output unit 4. The second information exchange unit 22 receives the bus observation code B from the second microprocessor 21 and outputs the bus observation code B to the second collating unit 23 and the first information exchange unit 12 in the first operation unit 10. Also, the second information exchange unit 22 receives a bus observation code A from the first information exchange unit 12 and outputs the bus observation code A to the second collating unit 23. That is, the second information exchange unit 22 performs the code exchange. The second collating unit 23 receives the bus observation code A and the bus observation code B from the second information exchange unit 22 and collates the bus observation code A with the bus observation code B. If the bus observation code A does not correspond to the bus observation code B, then the second collating unit 23 outputs a second discrepancy detection signal to the standardized signal output unit 4.

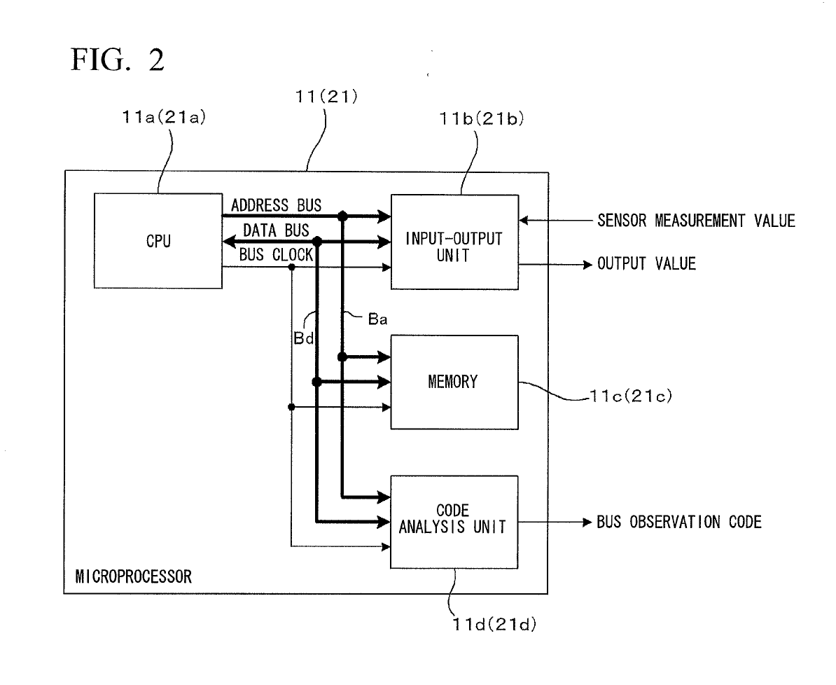

FIG. 2 is a block diagram illustrating a configuration of the first microprocessor 11 and the second microprocessor 21. The first microprocessor 11 and the second microprocessor 21 have the same configuration.

The first microprocessor 11 includes a first CPU 11a, a first input-output unit 11b, first memory 11c, and a first code analysis unit 11d. The first CPU 11a, the first input-output unit 11b, the first memory 11c, and the first code analysis unit 11d are connected to each other through an address bus Ba and a data bus Bd. The first CPU 11a outputs a bus clock to the first input-output unit 11b, the first memory 11c, and the first code analysis unit 11d. The first input-output unit 11b controls input and output of data between the first CPU 11a and outside of the first microprocessor 11. The first input-output unit 11b receives the sensor measurement value from the measurement sensor 3 and outputs the first output value to the standardized signal output unit 4. The first CPU 11a reads and writes data stored in the first memory 11c during the operation. The first code analysis unit 11d receives and encodes data on the address bus Ba and the data bus Bd and outputs the bus observation code A to the first information exchange unit 12.

In the same way, the second microprocessor 21 includes a second CPU 21a, a second input-output unit 21b, a second memory 21c, and a second code analysis unit 21d. The second CPU 21a, the second input-output unit 21b, the second memory 21c, and the second code analysis unit 21d are connected each other through an address bus Ba and a data bus Bd. The second CPU 21a outputs a bus clock to the second input-output unit 21b, the second memory 21c, and the second code analysis unit 21d. The second input-output unit 21b controls input and output of data between the second CPU 21a and outside of the second microprocessor 21. The second input-output unit 21b receives the sensor measurement value from the measurement sensor 3 and outputs the second output value to the standardized signal output unit 4. The second CPU 21a reads and writes data stored in the second memory 21c during the operation. The second code analysis unit 21d receives and encodes data on the address bus Ba and the data bus Bd and outputs the bus observation code B to the second information exchange unit 22.

Next, the operation of the dual field instrument in accordance with the first preferred embodiment of the present invention will be described.

The sensor measurement value from the measurement sensor 3 is input to the first microprocessor 11 and the second microprocessor 21. The first microprocessor 11 and the second microprocessor 21 respectively perform the same operation based on the sensor measurement value. The first microprocessor 11 outputs the result of the operation as the first output value to the standardized signal output unit 4. The second microprocessor 21 outputs the result of the operation as the second output value to the standardized signal output unit 4.

The first CPU 11a receives the sensor measurement value through the first input-output unit 11b. Then, the first CPU 11a performs the operation based on the program stored in the first memory 11c and outputs the result of the operation to the standardized signal output unit 4 through the first input-output unit 11b. The first code analysis unit 11d reads data on the address bus Ba and the data bus Bd. Then, the first code analysis unit 11d encodes and compresses the data at each bus clock to output as the bus observation code A.

Similarly, the second CPU 21a receives the sensor measurement value through the second input-output unit 21b. Then, the second CPU 21a performs the operation based on the program stored in the second memory 21c and outputs the result of the operation to the standardized signal output unit 4 through the second input-output unit 21b. The second code analysis unit 21d reads data on the address bus Ba and the data bus Bd. Then, the second code analysis unit 21d encodes and compresses the data at each bus clock to output as the bus observation code B.

The first code analysis unit 11d and the second code analysis unit 21d may have a general configuration having a linear feedback shift register. The first code analysis unit 11d outputs a change history of a data pattern in each bus as the bus observation code A. Similarly, the second code analysis unit 21d outputs a change history of a data pattern in each bus as the bus observation code B. The data pattern is a signal pattern of multiple-bits. The bus observation code A and the bus observation code B are codes of serial bit stream. The history of the data pattern in each bus can be observed without affecting the processes of the first CPU 11a and the second CPU 21a. Encoding of the data pattern in each bus may be performed by a general method that is disclosed in “Testing by feedback shift register”, IEEE Transactions on Computers Vol. C-29, No. 7, pp. 668-673, July 1980, for example.

The bus observation code A output from the first code analysis unit 11d is received by the first information exchange unit 12. The bus observation code B output from the second code analysis unit 21d is received by the second information exchange unit 22. The bus observation code A and the bus observation code B are exchanged by the first information exchange unit 12 and the second information exchange unit 22 respectively. The first information exchange unit 12 synchronizes the bus observation code A with the bus observation code B. The second information exchange unit 22 synchronizes the bus observation code B with the bus observation code A.

The first information exchange unit 12 outputs the synchronized bus observation code A and the synchronized bus observation code B to the first collating unit 13. The second information exchange unit 22 outputs the synchronized bus observation code A and the synchronized bus observation code B to the second collating unit 23.

The first collating unit 13 compares the synchronized bus observation code A with the synchronized bus observation code B to detect discrepancy between the synchronized bus observation code A and the synchronized bus observation code B. The second collating unit 23 compares the synchronized bus observation code B with the synchronized bus observation code A to detect discrepancies between the synchronized bus observation code A and the synchronized bus observation code B.

If the first collating unit 13 detects discrepancy, then the first collating unit 13 outputs the first discrepancy detection signal to the standardized signal output unit 4. If the second collating unit 23 detects a discrepancy, then the second collating unit 23 outputs the second discrepancy detection signal to the standardized signal output unit 4.

If neither the first discrepancy detection signal nor the second discrepancy detection signal is input to the standardized signal output unit 4, then the standardized signal output unit 4 outputs standard 4-20 mA current loop signal as the standardized signal current, based on the first output value from the first microprocessor 11 or the second output value from the second microprocessor 21 or both the first output value and the second output value.

If at least one of the first discrepancy detection signal and the second discrepancy detection signal is input to the standardized signal output unit 4, then the standardized signal output unit 4 outputs an abnormality annunciation current that is predetermined as the standardized signal current. Thereby, occurrence of abnormality is annunciated. In the first preferred embodiment of the present invention, two information exchange units and two collating units are disposed. Therefore, an abnormality of the process in the information exchange unit and the collating unit can also be detected.

When neither the first discrepancy detection signal nor the second discrepancy detection signal is input to the standardized signal output unit 4, if the first output value from the first microprocessor 11 is different from the second output value from the second microprocessor 21, then the standardized signal output unit 4 may output the abnormality annunciation current.

As described above, the dual field instrument in accordance with the first preferred embodiment of the present invention compresses and encodes histories of CPU buses of two microprocessors that perform the same operation process to generate codes, and collates the codes to determine sequentially whether or not the operation process has abnormality. Therefore, abnormality in the operation process can be detected with high precision and with high speed.

An additional process of exchanging information or collating the exchanged information need not be added to the program of the operation process. Therefore, the burden on the microprocessor is decreased, and decline of the processing power in the operation process can be avoided.

Codes generated by the code analysis units are collated. Thereby, the amount of the information to be collated is less than in the case of collating data of the CPU bus directly. Therefore, a reduction in power consumption and cut to the cost of system can be attained.

The area of collating can be made smaller than in the case of collating the operation result at each operation step. Thereby, the degree of accuracy in detecting abnormalities can be increased.

The dual field instrument in accordance with the first preferred embodiment of the present invention continuously performs the encoding based on data on the address bus and the data bus of the CPU. The information of the bus that is encoded may be limited to a specified address.

A first program that defines the operation process performed by the two microprocessors and a second program that defines other processes may be separately stored on the memory. That is, the address area storing the first program and the address area storing the second program are separated. Then, only the data in the address area storing the first program may be encoded.

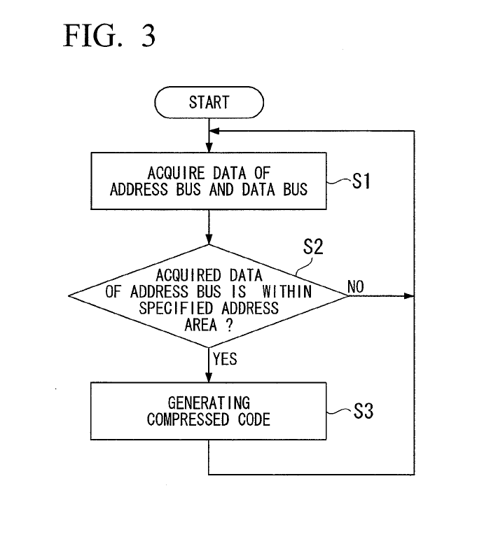

FIG. 3 is a flowchart illustrating an operation of the first code analysis unit 11d and the second code analysis unit 21d when only data in a specified address area is encoded. The specified address area is the address area storing the first program that defines the operation process performed by the two microprocessors.

In step S1 of FIG. 3, the first code analysis unit 11d and the second code analysis unit 21d respectively acquire data from the address bus and the data bus at a timing based on the bus clock.

Next, in step S2, the first code analysis unit 11d and the second code analysis unit 21d respectively determine whether or not the acquired data from the address bus is within the specified address area. If the acquired data from the address bus is the specified address, then go to step S3. If the acquired data from the address bus is not the specified address, then return to the step S1.

In the step S3, codes are generated by the first code analysis unit 11d and the second code analysis unit 21d compressing and encoding the acquired data from the address bus and the data bus that is acquired in the step S1, then return to the step S1.

As described above, in the process of FIG. 3, encoding is performed only when the data acquired from the address bus is within the specified address area. All of the operation process is not necessary to be synchronized. Only the operation process corresponding to the first program needs to be synchronized. Therefore, the process of synchronizing can be performed easily. For example, a first series of process that performs the encoding operation and a second series of process that does not need the encoding operation may be repeated alternately at a constant cycle. Thereby, the phase of the process can be detected easily. The burden in performing the synchronizing process can be decreased.

The data on the bus that is to be encoded is limited, and two microprocessors may respectively perform different processes except the first program.

As described above, in the dual field instrument of the present invention, histories of multiple-bit data on the address bus and the data bus of the two microprocessors are respectively compressed and encoded to generate codes. Then, the generated codes are collated. Thereby, the burden on the microprocessor is suppressed. An abnormality can be detected with high precision and high speed.

As used herein, the following directional terms “forward, rearward, above, downward, vertical, horizontal, below, and transverse” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” “nearly”, and “approximately” as used herein mean a reasonable amount of deviation of the modified term such that the end result is not significantly changed. For example, these terms can be construed as including a deviation of at least ±5 percents of the modified term if this deviation would not negate the meaning of the word it modifies.

The term “unit” is used to describe a component, section or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. The present invention can be applied to any dual field instrument that includes two microprocessors performing the same operation process and detects an abnormality by collating the operation processes of the two microprocessors. Accordingly, the present invention is not to be considered as being limited by the foregoing description, and is only limited by the scope of the claims.

What is claimed is:

1. A dual field instrument comprising:
a first microprocessor that includes a first address bus and a first data bus, the first microprocessor performing a first operation process;
a second microprocessor that includes a second address bus and a second data bus, the second microprocessor performing a second operation process;
a first code analysis unit that compresses and encodes histories of data on at least one of the first address bus and the first data bus to generate a first code by a first process;
a second code analysis unit that compresses and encodes histories of data on at least one of the second address bus and the second data bus to generate a second code by a second process; and
a first collating unit that collates the first code with the second code so as to determine whether or not the first code corresponds with the second code.

2. The dual field instrument according to claim 1, wherein the first process is the same with the second process.

3. The dual field instrument according to claim 1, wherein
the first process is performed when data on the first address bus is within a specified address area, and
the second process is performed when data on the second address bus is within the specified address area.

4. The dual field instrument according to claim 3, wherein
the specified address area is an address area of a memory that stores a program defining at least one of the first operation process and the second operation process.

5. The dual field instrument according to claim 1, wherein
each of the first code analysis unit and the second code analysis unit includes a linear feedback shift register.

6. The dual field instrument according to claim 1, further comprising a signal output unit, and wherein
if the first collating unit determines that the first code corresponds with the second code, then the signal output unit outputs one of a first operation result of the first operation process and a second operation result of the second operation process, and wherein
if the first collating unit determines that the first code does not correspond with the second code, then the signal output unit outputs an abnormality annunciation signal.

7. The dual field instrument according to claim 1, further comprising:
a first information exchange unit that receives the first code from the first code analysis unit, the first information exchange unit receiving the second code from a second information exchange unit, the first information exchange unit outputting the first code and the second code to the first collating unit;
the second information exchange unit that receives the second code from the second code analysis unit, the second information exchange unit receiving the first code from the first information exchange unit, the second information exchange unit outputting the first code and the second code to a second collating unit; and
the second collating unit that receives the first code and the second code from the second information exchange unit, the second collating unit collating the first code with the second code so as to determine whether or not the first code corresponds with the second code, and
wherein the first collating unit receives the first code and the second code from the first information exchange unit.

8. A dual field instrument comprising:
a first microprocessor that receives a sensor measurement value, the first microprocessor performing a first operation process to generate a first output value, the first microprocessor outputting a first code;
a second microprocessor that receives the sensor measurement value, the second microprocessor performing a second operation process to generate a second output value, the second microprocessor outputting a second code, the second operation process being the same with the first operation process;
a first information exchange unit that receives the first code from the first microprocessor, the first information exchange unit receiving the second code from a second information exchange unit, the first information exchange unit outputting the first code and the second code to a first collating unit;
the second information exchange unit that receives the second code from the second microprocessor, the second information exchange unit receiving the first code from the first information exchange unit, the second information exchange unit outputting the first code and the second code to a second collating unit;
the first collating unit that receives the first code and the second code from the first information exchange unit, the first collating unit collating the first code with the second code so as to determine whether or not the first code corresponds with the second code; and
the second collating unit that receives the first code and the second code from the second information exchange unit, the second collating unit collating the first code with the second code so as to determine whether or not the first code corresponds with the second code.

9. The dual field instrument according to claim 8, wherein
if the first collating unit determines that the first code does not correspond with the second code, then the first collating unit outputs a first discrepancy detection signal, and
if the second collating unit determines that the first code does not correspond with the second code, then the second collating unit outputs a second discrepancy detection signal.

10. The dual field instrument according to claim 9, further comprising:
a standardized signal output unit that receives the first output value from the first microprocessor, the standardized signal output unit receiving the second output value from the second microprocessor, the standardized signal output unit receiving the first discrepancy detection signal from the first collating unit, the standardized signal output unit receiving the second discrepancy detection signal from the second collating unit, the standardized signal output unit outputting a standardized signal current.

11. The dual field instrument according to claim 10, wherein
if neither the first discrepancy detection signal nor the second discrepancy detection signal is input to the standardized signal output unit, then the standardized signal output unit outputs 4-20 mA current as the standardized signal current, based on at least one of the first output value of the first microprocessor and the second output value from the second microprocessor.

12. The dual field instrument according to claim 10, wherein
if at least one of the first discrepancy detection signal and the second discrepancy detection signal is input to the standardized signal output unit, then the standardized signal output unit outputs a predetermined abnormality annunciation current as the standardized signal current.

13. The dual field instrument according to claim 10, wherein
if the first output value from the first microprocessor is different from the second output value from the second microprocessor, then the standardized signal output unit outputs a predetermined abnormality annunciation current as the standardized signal current.

14. The dual field instrument according to claim 8, wherein
the first microprocessor comprising:
a first CPU that performs the first operation process;
a first input-output unit that receives the sensor measurement value, the first input-output unit outputting the first output value;
a first memory that stores a first program performing the first operation process;
a first code analysis unit that outputs the first bus observation code;
a first address bus that connects between the first CPU, the first input-output unit, the first memory and the first code analysis unit; and
a first data bus that connects between the first CPU, the first input-output unit, the first memory and the first code analysis unit, and
the second microprocessor comprising:
a second CPU that performs the second operation process;
a second input-output unit that receives the sensor measurement value, the second input-output unit outputting the second output value;
a second memory that stores a second program performing the second operation process;
a second code analysis unit that outputs the second bus observation code;
a second address bus that connects between the second CPU, the second input-output unit, the second memory and the second code analysis unit; and
a second data bus that connects between the second CPU, the second input-output unit, the second memory and the second code analysis unit.

15. The dual field instrument according to claim 14, wherein
the first CPU outputs a first bus clock, the first code analysis unit receives the first bus clock,
the second CPU outputs a second bus clock, and the second code analysis unit receives the second bus clock.

16. The dual field instrument according to claim 15, wherein
the first code analysis unit reads first data on the first address bus and the first data bus, the first code analysis unit encodes and compresses the first data based on the first bus clock to generate the first bus observation code,
the second code analysis unit reads second data on the second address bus and the second data bus, and the second code analysis unit encodes and compresses the second data based on the second bus clock to generate the second bus observation code.

17. The dual field instrument according to claim 14, wherein
the first code analysis unit outputs a change history of a data pattern in each of the first address bus and the data address bus as the first bus observation code,
the second code analysis unit outputs a change history of a data pattern in each of the second address bus and the second data bus as the second bus observation code, and
the first bus observation code and the second bus observation code are codes of serial bit stream.

18. The dual field instrument according to claim 16, wherein
if data on the first address bus is within a first specified address area, then the first code analysis unit encodes and compresses the first data, and
if data on the second address bus is within a second specified address area, then the second code analysis unit encodes and compresses the second data.

19. The dual field instrument according to claim 14, wherein
each of the first code analysis unit and the second code analysis unit includes a linear feedback shift register.
